(19) United States
(12) Patent Application Publication
(10) Pub. No.: US 2019/0332823 A1
(43) Pub. Date: Oct. 31, 2019

(54) INTRUSION RESPONSE APPARATUS AND METHOD FOR VEHICLE NETWORK

(71) Applicant: ELECTRONICS AND TELECOMMUNICATIONS RESEARCH INSTITUTE, Daejeon (KR)

(72) Inventors: Hyeok-Chan KWON, Daejeon (KR); Sok-Joon LEE, Daejeon (KR); Byung-Ho CHUNG, Daejeon (KR); Joong-Yong CHOI, Sejong-si (KR)

(73) Assignee: ELECTRONICS AND TELECOMMUNICATIONS RESEARCH INSTITUTE, Daejeon (KR)

(21) Appl. No.: 16/384,252

(22) Filed: Apr. 15, 2019

(30) Foreign Application Priority Data
Apr. 27, 2018 (KR) 10-2018-0049301

(51) Int. Cl. G06F 21/85; G06F 21/55; H04L 12/40

(52) U.S. Cl. CPC G06F 21/85; G06F 21/554; H04L 2012/40273; H04L 2012/40215; H04L 12/40

(57) ABSTRACT

Disclosed herein are an intrusion response apparatus and method for a vehicle network. The intrusion response method for a vehicle network is performed by an intrusion response apparatus for the vehicle network, and includes receiving attack detection information about an intrusive attack on the vehicle network from an intrusion detection system, selecting at least one target electronic control unit that is to be instructed to respond to the intrusive attack from among multiple electronic control units, and sending a response instruction message to the at least one target electronic control unit so that the target electronic control unit responds to the intrusive attack.

### CROSS REFERENCE TO RELATED APPLICATION

This application claims the benefit of Korean Patent Application No. 10-2018-0049301, filed Apr. 27, 2018, which is hereby incorporated by reference in its entirety into this application.

### BACKGROUND OF THE INVENTION

### 1. Technical Field

The present invention relates generally to technology for responding to an intrusion into a vehicle network, and more particularly, to technology for responding to an invasive attack on an in-vehicle network in order to mitigate damage caused by the invasive attack when the invasive attack on the in-vehicle network occurs.

### 2. Description of the Related Art

Recently, connected car technology, in which network connection is enabled and in which in-vehicle/out-vehicle networks are connected to each other via wireless communication and then a physical system is provided, has been greatly developed. Further, with the development of connected car technology, it has been proven through a lot of research and experimentation that an in-vehicle computer system can be the target of hacking.

The core of vehicle security is to detect and block attacks such as an attack to inject unauthorized data into an in-vehicle network and a Denial of Service (DoS) attack to damage vehicle availability. Recently, examples of systems for detecting an intrusion into an in-vehicle network include a vehicle firewall, an Intrusion Detection System (IDS) for vehicles, etc.

Generally, a vehicle firewall employs a scheme for controlling access to an in-vehicle network based on rules or whitelists either at the point of entry into the in-vehicle network or in the in-vehicle network. At this time, entry into the in-vehicle network is enabled through a head unit or an On-Board Diagnostic (OBD) port, and access control may be realized in the in-vehicle network based on a gateway or an exclusive detection Electronic Control Unit (ECU). Further, the vehicle firewall may allow or block packet injection into the in-vehicle network by aggregating the diagnostic status or driving status of a vehicle, a Controller Area Network (CAN) identifier (ID), payload check (Deep Packet Injection: DPI) of a CAN packet, information about allowed or blocked applications, etc.

Also, the IDS for vehicles detects a symptom of attacks by analyzing features such as the pattern or period of traffic that is transmitted over the in-vehicle network.

Further, when an intrusive attack on an in-vehicle network is detected, passive measures, such as outputting a warning alarm to a dashboard of a vehicle, a vehicle management center or a user or by stopping the vehicle, are taken, after which post management is performed by executing a security update. That is, even if an attack packet injected into the in-vehicle network is detected, it is impossible to respond to such an invasive attack (or an intrusive attack).

Therefore, required is the development of response technology for, when an attack packet injected into an in-vehicle network is detected, mitigating the attack.

### PRIOR ART DOCUMENTS

### Patent Documents

(Patent Document 1) Korean Patent No. 10-1781134, Date of Publication: Sep. 22, 2017 (Title: Method for Managing Secured Communication of Car Network)

### SUMMARY OF THE INVENTION

Accordingly, the present invention has been made keeping in mind the above problems occurring in the prior art, and an object of the present invention is to take measures for responding to and mitigating an intrusion into an in-vehicle network in real time in order to minimize damage caused by the intrusion when an intrusion into the in-vehicle network is detected.

Another object of the present invention is to secure vehicle availability and respond to an invasive attack on an in-vehicle network when an intrusion into the in-vehicle network is detected.

In accordance with an aspect of the present invention to accomplish the above objects, there is provided an intrusion response method for a vehicle network, performed by an intrusion response apparatus for the vehicle network, the intrusion response method including receiving attack detection information about an intrusive attack on the vehicle network from an intrusion detection system, selecting at least one target electronic control unit that is to be instructed to respond to the intrusive attack from among multiple electronic control units, and sending a response instruction message to the at least one target electronic control unit so that the target electronic control unit responds to the intrusive attack.

Receiving the attack detection information may be configured to receive the attack detection information including at least one of a Controller Area Network (CAN) identifier (ID) of an attack packet detected by the intrusion detection system, a presumably damaged electronic control unit expected to be damaged by the intrusive attack, and a type of the intrusive attack.

Selecting the target electronic control unit may be configured to select, as the target electronic control unit, at least one of the presumably damaged electronic control unit expected to be damaged by the intrusive attack on the vehicle network and an electronic control unit selected based on a priority.

Sending the response instruction message to the target electronic control unit may be configured to send a response instruction message for instructing the target electronic control unit to perform at least one of a reboot operation, an operation of switching to a safe mode, and an operation of changing configuration information thereof.

Sending the response instruction message to the target electronic control unit may be configured to send a response instruction message including the CAN ID to the target electronic control unit, thus allowing the target electronic control unit to discard a packet corresponding to the CAN ID.

Selecting the target electronic control unit may be configured to, when the detected intrusive attack is an attack made through an infotainment system, select an electronic control unit included in an infotainment domain as the target electronic control unit.

Sending the response instruction message to the target electronic control unit may be configured to send a response instruction message for instructing the target electronic control unit to change configuration information of the infotainment system.

Selecting the target electronic control unit may be configured to, when the vehicle network comprises a domain gateway, select the domain gateway as a target that is to be instructed to respond to the intrusive attack.

Sending the response instruction message to the target electronic control unit may be configured to send a response instruction message for instructing the domain gateway, selected as the target, to perform at least one of an operation of changing domain configuration information, an operation of switching the domain to a security mode, and an operation of discarding a packet corresponding to the CAN ID.

Sending the response instruction message to the target electronic control unit may be configured to send a response instruction message for instructing the target electronic control unit to modify a Remote Transmission Request (RTR) bit of a broadcasted packet having the CAN ID of the attack packet.

An electronic control unit, having received the broadcasted packet, may be configured to, when the electronic control unit is not an electronic control unit corresponding to the CAN ID of the attack packet, discard the packet.

In accordance with another aspect of the present invention to accomplish the above objects, there is provided an intrusion response apparatus for a vehicle network, including an attack detection information reception unit for receiving attack detection information about an intrusive attack on a vehicle network from an intrusion detection system, an instruction target selection unit for selecting at least one target electronic control unit that is to be instructed to respond to the intrusive attack, from among multiple electronic control units, and a response instruction message sending unit for sending a response instruction message to the at least one target electronic control unit so that the target electronic control unit responds to the intrusive attack.

The attack detection information reception unit may be configured to receive the attack detection information including at least one of a Controller Area Network (CAN) identifier (ID) of an attack packet detected by the intrusion detection system, a presumably damaged electronic control unit expected to be damaged by the intrusive attack, and a type of the intrusive attack.

The instruction target selection unit may be configured to select, as the target electronic control unit, at least one of the presumably damaged electronic control unit expected to be damaged by the intrusive attack on the vehicle network and an electronic control unit selected based on a priority.

The response instruction message sending unit may be configured to send a response instruction message for instructing the target electronic control unit to perform at least one of a reboot operation, an operation of switching to a safe mode, and an operation of changing configuration information thereof.

The response instruction message sending unit may be configured to send a response instruction message including the CAN ID to the target electronic control unit, thus allowing the target electronic control unit to discard a packet corresponding to the CAN ID.

The instruction target selection unit may be configured to, when the detected intrusive attack is an attack made through an infotainment system, select an electronic control unit included in an infotainment domain as the target electronic control unit.

The response instruction message sending unit may be configured to send a response instruction message for instructing the target electronic control unit to change configuration information of the infotainment system.

The response instruction message sending unit may be configured to send a response instruction message for instructing a domain gateway, selected as a target that is to be instructed to respond to the intrusive attack, from among domain gateways included in the vehicle network, to perform at least one of an operation of changing domain configuration information, an operation of switching the domain to a security mode, and an operation of discarding a packet corresponding to the CAN ID.

The response instruction message sending unit may be configured to send a response instruction message for instructing the target electronic control unit to modify a Remote Transmission Request (RTR) bit of a broadcasted packet having the CAN ID of the attack packet.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating an environment in which an intrusion response apparatus for a vehicle network according to an embodiment of the present invention is applied;

FIG. 2 is a block diagram illustrating the configuration of an intrusion response apparatus for a vehicle network according to an embodiment of the present invention;

FIG. 3 is a flowchart illustrating an intrusion response method for a vehicle network according to an embodiment of the present invention;

FIG. 4 is a diagram illustrating a first intrusion response method according to an embodiment of the present invention;

FIG. 5 is a diagram illustrating a second intrusion response method according to an embodiment of the present invention;

FIG. 6 is a diagram illustrating a third intrusion response method according to an embodiment of the present invention;

FIG. 7 is a diagram illustrating a fourth intrusion response method according to an embodiment of the present invention;

FIG. 8 is a diagram illustrating a fifth intrusion response method according to an embodiment of the present invention;

FIG. 9 is a diagram illustrating the structure of a CAN packet according to an embodiment of the present invention; and

FIG. 10 is a block diagram illustrating a computer system according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

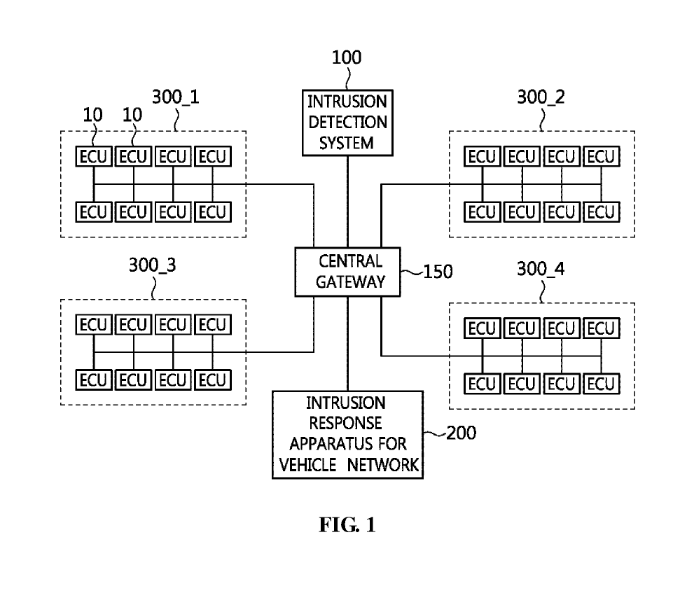

FIG. 1 is a diagram schematically illustrating an environment to which an intrusion response apparatus for a vehicle network according to an embodiment of the present invention is applied.

An intrusion response apparatus 200 for a vehicle network according to the embodiment of the present invention is configured to, when an attack such as an intrusion into the vehicle network is detected, respond to such an intrusive attack so as to mitigate the damage caused by the intrusive attack.

As illustrated in FIG. 1, when an intrusion detection system (IDS) 100 detects an intrusive attack on the vehicle network, the intrusion response apparatus 200 for the vehicle network may send a control message to Electronic Control Units (ECUs) 10 so as to mitigate the damage caused by the attack and respond to the attack.

In particular, the intrusion response apparatus 200 for the vehicle network may be connected to the intrusion detection system 100 or to the ECUs 10 through a central gateway 150. The intrusion detection system 100, which is a system for detecting an intrusive attack (also referred to as an “invasive attack”) on the in-vehicle network, may be a normal intrusion detection system (IDS).

Further, when an invasive attack is detected by the intrusion detection system 100, the intrusion response apparatus 200 for the vehicle network mitigates damage to the vehicle caused by the invasive attack and responds to the invasive attack. Here, the intrusion response apparatus 200 for the vehicle network may select a target that is to be instructed to respond to the invasive attack, and may send a response instruction message to the selected target, thus responding to the invasive attack.

The intrusion response apparatus 200 for the vehicle network may be implemented as a separate device or may be mounted in the form of a software (SW) module on the central gateway 150 or the like. Here, the central gateway 150 performs access control by deciding whether to permit a request to access the in-vehicle network based on a token.

The ECUs 10 control the driving unit of the vehicle and execute commands from a driver in the in-vehicle network without being connected to the outside of the vehicle. A vehicle domain 300 may be classified into a powertrain domain 300_1, a chassis/safety domain 300_2, a body domain 300_3, and an infotainment domain 300_4 including a head unit, an In-Vehicle Infotainment (IVI) system, etc. Also, one or more ECUs 10 may be included in each domain. Further, the transfer and exchange of information between individual ECUs 10 may be performed through a Controller Area Network (CAN)-type controller.

The ECUs 10 may be divided into target ECUs which process tasks for mitigating the damage caused by intrusive attacks and responding to intrusive attacks in response to instructions from the intrusion response apparatus 200 for the vehicle network and presumably damaged ECUs which are expected to be damaged by the invasive attacks. Furthermore, each ECU 10 may be equipped with a response agent module, which is a software module in which some functions processed by the corresponding ECU 10 are installed so as to respond to the invasive attacks.

Hereinafter, the configuration of an intrusion response apparatus for a vehicle network according to an embodiment of the present invention will be described in detail.

FIG. 2 is a block diagram illustrating the configuration of an intrusion response apparatus for a vehicle network according to an embodiment of the present invention.

As illustrated in FIG. 2, the intrusion response apparatus 200 for the vehicle network according to the embodiment of the present invention includes an attack detection information reception unit 210, an instruction target selection unit 220, and a response instruction message sending unit 230.

First, the attack detection information reception unit 210 receives information about detection of an attack from the intrusion detection system 100. Here, the attack detection information is generated and transmitted by the intrusion detection system 100 when the intrusion detection system 100 detects an intrusive attack on a vehicle network. The attack detection information may include at least one of a Controller Area Network (CAN) ID of an attack packet detected by the intrusion detection system, information about a presumably damaged ECU expected to be damaged by the attack, and the type of the attack.

Next, the instruction target selection unit 220 selects a target electronic control unit (hereinafter also referred to as a “target ECU”), which is a target to be instructed to respond to an intrusive attack, from among multiple electronic control units (ECUs) 10.

Here, the instruction target selection unit 220 may select one or more ECUs 10 as target ECUs, may select presumably damaged ECUs expected to be damaged by an intrusive attack on the vehicle network as the target ECUs, or may select the target ECUs based on priorities of the ECUs.

Further, when the detected intrusive attack is an attack made through any one domain, the instruction target selection unit 220 may select ECUs 10 included in the corresponding domain as the target ECUs. For example, when an intrusive attack is an attack made through an infotainment system, the instruction target selection unit 220 may select ECUs 10 included in an infotainment domain as the target ECUs.

Finally, the response instruction message sending unit 230 sends a response instruction message to the one or more target ECUs so that the target ECUs respond to the intrusive attack.

The response instruction message sending unit 230 may generate a response instruction message for instructing the target ECUs to reboot, switch to a safe mode, or change ECU configuration information, and may send the response instruction message to the target ECUs.

Also, the response instruction message sending unit 230 sends a response instruction message including a CAN ID to the target ECUs, and then allows the target ECUs to discard a packet corresponding to the CAN ID.

Further, when the detected intrusive attack is an attack made through an infotainment system, the response instruction message sending unit 230 may send a response instruction message for instructing target ECUs, which are ECUs 10 included in the infotainment domain, to change infotainment configuration information to the target ECUs.

When the instruction target selection unit 220 selects a domain gateway, as a target that is to be instructed to respond to an intrusive attack, from among domain gateways included in the vehicle network, the response instruction message sending unit 230 may generate a response instruction message for instructing the selected domain gateway to change domain configuration information, switch the domain to a security mode, or discard a packet corresponding to a CAN ID, and may send the generated response instruction message to the corresponding domain gateway.

Furthermore, the response instruction message sending unit 230 may generate a response instruction message for instructing the target ECUs to modify a Remote Transmission Request (RTR) bit of a broadcasted packet including the CAN ID of an attack packet, and may send the response instruction message to the target ECUs.

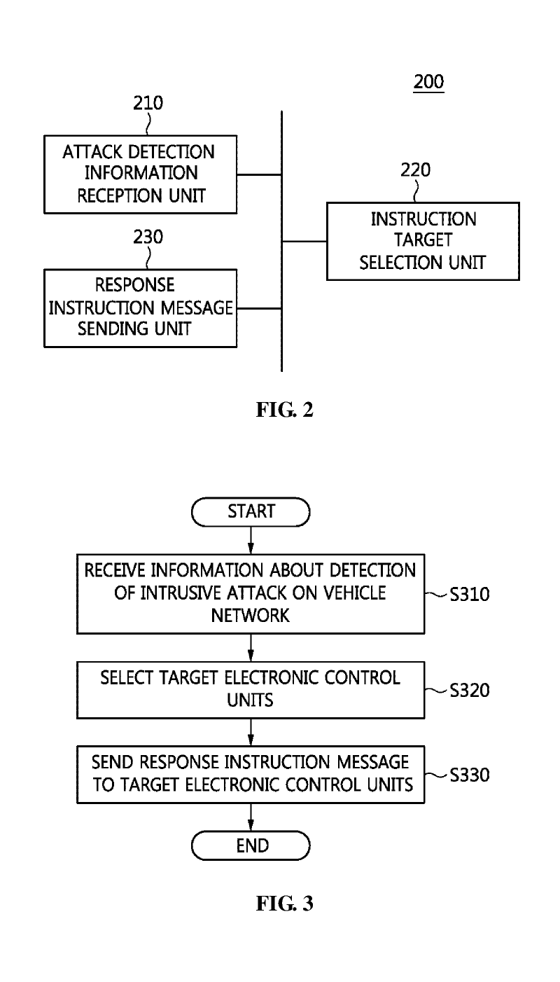

Hereinafter, an intrusion response method for a vehicle network, performed by the intrusion response apparatus for the vehicle network, according to embodiments of the present invention will be described in detail with reference to FIGS. 3 to 9.

FIG. 3 is a flowchart illustrating an intrusion response method for a vehicle network according to an embodiment of the present invention.

First, the intrusion response apparatus 200 for the vehicle network receives information about detection of an intrusive attack from an intrusion detection system 100, which is a system for detecting an intrusive attack on the vehicle network (e.g. in-vehicle network), at step S310.

The intrusion detection system 100 is a system for detecting an attack such as an intrusion into the in-vehicle network, and is configured to, when an attack is detected, transmit intrusive attack detection information, which is information about the detected attack, to the intrusion response apparatus 200 for the vehicle network.

Here, the intrusive attack detection information may include at least one of a Controller Area Network (CAN) ID of an attack packet detected by the intrusion detection system 100, information about a presumably damaged ECU expected to be damaged by the attack, and the type of the attack.

The intrusion response apparatus 200 for the vehicle network may be implemented as a device separate from the intrusion detection system 100, or may be implemented to be mounted in the intrusion detection system 100.

Next, the intrusion response apparatus 200 for the vehicle network selects target electronic control units (target ECUs) at step S320.

The intrusion response apparatus 200 for the vehicle network, having received the intrusive attack detection information from the network intrusion detection system 100, selects one or more target ECUs based on the intrusive attack detection information. Here, the term “target ECU” refers to an ECU that is to be instructed to respond to an intrusive attack.

For convenience of description, the intrusion response apparatus 200 for the vehicle network has been described as selecting target ECUs which are instructed to respond to an intrusive attack from among multiple ECUs. However, the configuration of the present invention is not limited thereto, and the intrusion response apparatus 200 for the vehicle network may select all ECUs or domain gateways included in a certain domain as targets which are instructed to respond to an intrusive attack.

Further, the intrusion response apparatus 200 for the vehicle network may select, as the target ECUs, presumably damaged ECUs expected to be damaged by the intrusive attack as a result of analysis of the intrusive attack detection information. Furthermore, the intrusion response apparatus 200 for the vehicle network may select the target ECUs based on the priorities of the ECUs.

Next, the intrusion response apparatus 200 for the vehicle network sends a response instruction message to the target ECUs at step S330.

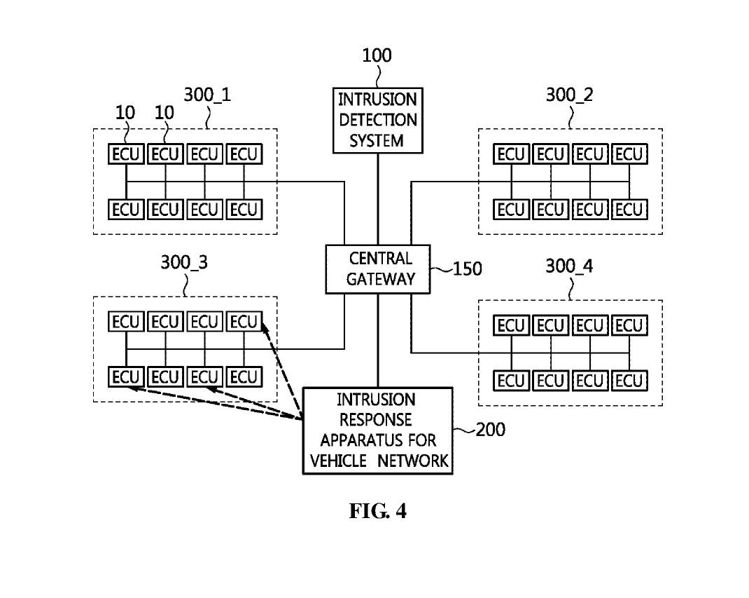

The intrusion response apparatus 200 for the vehicle network generates a response instruction message and sends the same to the target ECUs so that the target ECUs respond to the intrusive attack. Here, the intrusion response apparatus 200 for the vehicle network may generate the response instruction message based on a total of five intrusion response methods, and the intrusion response methods according to embodiments of the present invention will be described in greater detail below with reference to FIGS. 4 to 9.

FIG. 4 is a diagram illustrating a first intrusion response method according to an embodiment of the present invention.

As illustrated in FIG. 4, the intrusion response apparatus 200 for the vehicle network may select presumably damaged ECUs expected to be damaged by an intrusive attack as target ECUs, or may select the target ECUs based on the priorities of the ECUs.

Further, the intrusion response apparatus 200 for the vehicle network generates a response instruction message for instructing the one or more selected target ECUs to reboot, change ECU configuration information, or switch to a safe mode, and may send the response instruction message to the one or more target ECUs.

In particular, the intrusion response apparatus 200 for the vehicle network may change ECU configuration information so that the target ECUs switch to a safe mode, or may change ECU configuration information so that the target ECUs check integrity and confidentiality by activating secure communication.

Further, the safe mode may be either a mode that is set to allow only basic driving for vehicle safety, or a mode that is set to process only CAN packets (messages), the security of which has been verified. Designs for operations in the safe mode may be modified and applied in various forms as needed.

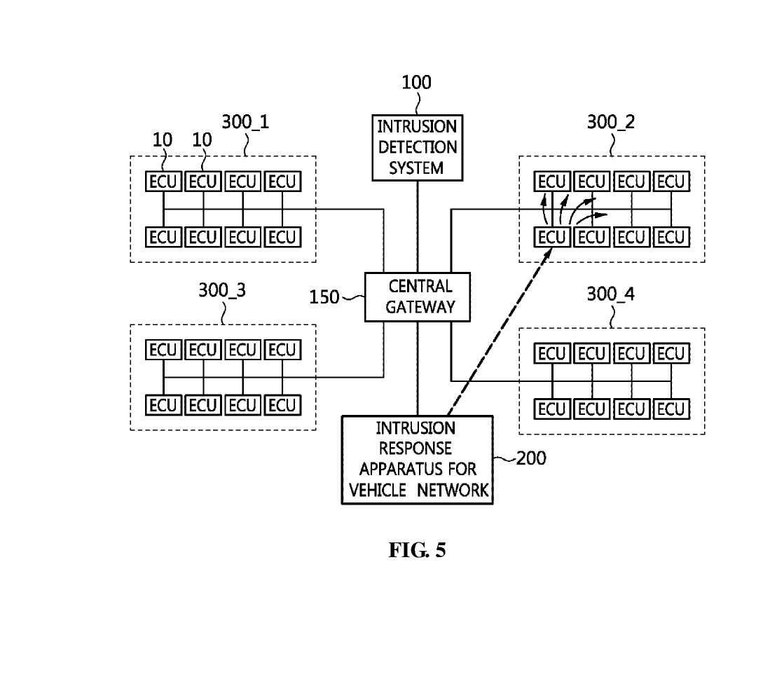

FIG. 5 is a diagram illustrating a second intrusion response method according to an embodiment of the present invention.

As illustrated in FIG. 5, the intrusion response apparatus 200 for the vehicle network may select ECUs installed in a specific domain 300_2 as target ECUs. Also, the intrusion response apparatus 200 for the vehicle network generates a response instruction message for instructing the target ECUs to discard a packet corresponding to a CAN ID, and may send the generated response instruction message to the target ECUs.

For example, the intrusion response apparatus 200 for the vehicle network may select ECUs installed in a chassis/safety domain 300_2 as the target ECUs, and may send a response instruction message to a responding ECU, which is one of the ECUs installed in the chassis/safety domain 300_2, thus allowing the responding ECU to broadcast the response instruction message to the target ECUs installed in the chassis/safety domain 300_2.

Here, the response instruction message includes a CAN ID, which is an object to be discarded by the target ECUs, and the target ECUs, having received the response instruction message broadcasted by the responding ECU, discard a packet including the corresponding CAN ID.

Further, when it is determined that the intrusive attack has been terminated, the intrusion response apparatus 200 for the vehicle network may send a message, indicating that the packet including the corresponding CAN ID is a normal packet, to the responding ECU, and the responding ECU may broadcast the message to the target ECUs included in the same domain.

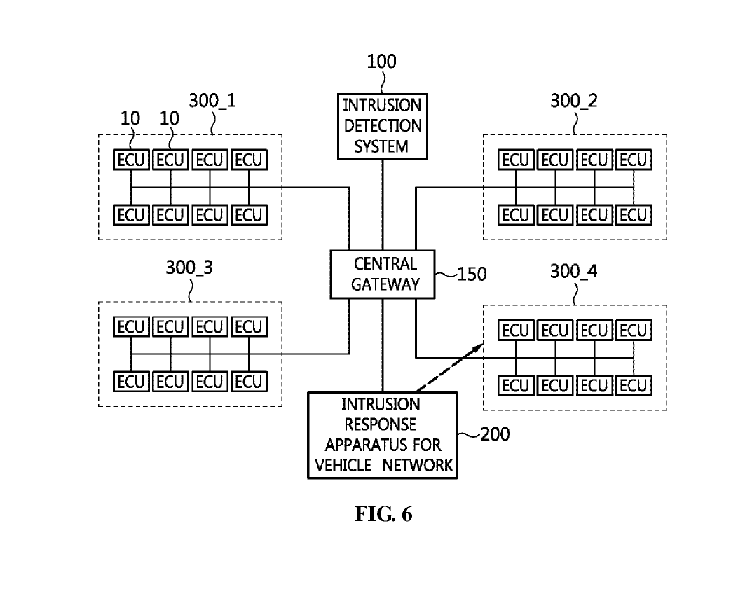

FIG. 6 is a diagram illustrating a third intrusion response method according to an embodiment of the present invention.

When an attack made through an infotainment system such as a head unit or an IVI system is detected, the intrusion response apparatus 200 for the vehicle network may select an infotainment domain 300_4 corresponding to the head unit as a target that is to be instructed to respond to an intrusive attack.

Also, the intrusion response apparatus 200 for the vehicle network may send a response instruction message to the infotainment domain 300_4, thus allowing the infotainment domain 300_4 to change the configuration of the head unit.

At this time, the response instruction message may be a message for issuing an instruction so that specific external communication is restricted, a specific packet is controlled, the execution of an application for injecting a specific packet is controlled, or an antivirus program is executed.

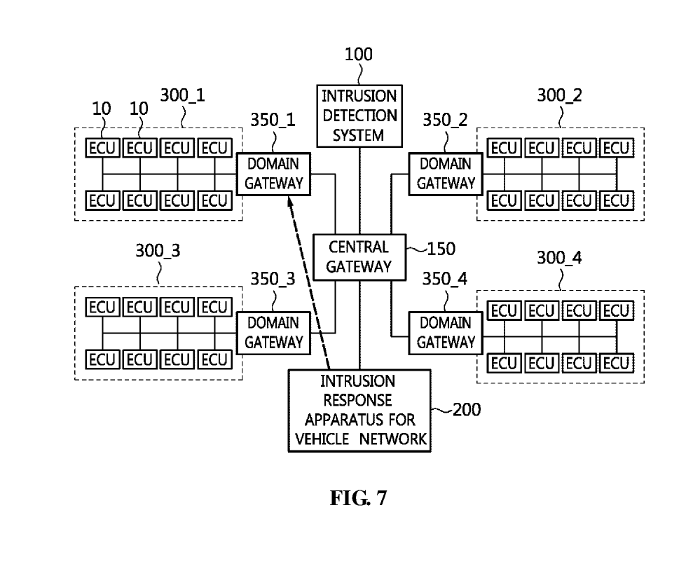

FIG. 7 is a diagram illustrating a fourth intrusion response method according to an embodiment of the present invention.

When there is a domain gateway 350, such as for Ethernet in the vehicle, the intrusion response apparatus 200 for the vehicle network may select at least one of domain gateways as a target that is to be instructed to respond to an intrusive attack.

For example, when the intrusion response apparatus 200 for the vehicle network selects a domain gateway 350_1 of a powertrain domain 300_1 as the target that is to be instructed to respond to the intrusive attack, the intrusion response apparatus 200 for the vehicle network may generate a response instruction message for instructing the domain gateway 350_1 to respond to the intrusive attack on a domain basis, and may send the generated response instruction message to the domain gateway 350_1.

Here, the intrusion response apparatus 200 for the vehicle network may generate a response instruction message for instructing the domain gateway to change domain configuration information, switch to a security mode, or discard a packet corresponding to a CAN ID. Also, the intrusion response apparatus 200 for the vehicle network may set the mode of the domain to a security mode, thus enabling the ECUs to send and receive encrypted messages or messages with signatures.

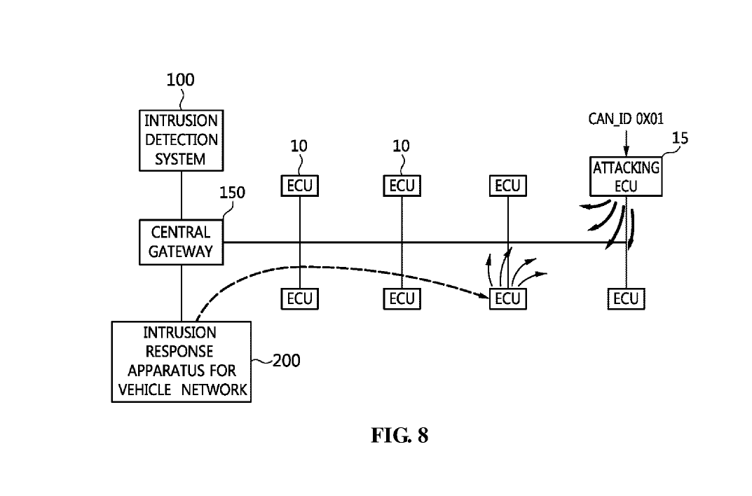

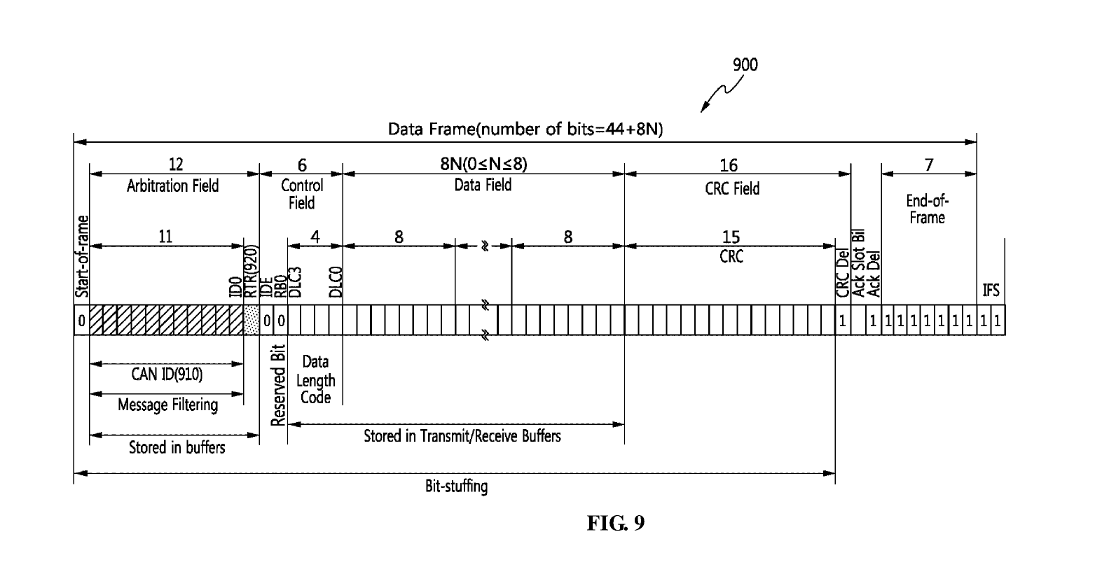

FIG. 8 is a diagram illustrating a fifth intrusion response method according to an embodiment of the present invention, and FIG. 9 is a diagram illustrating the structure of a CAN packet according to an embodiment of the present invention.

As illustrated in FIG. 8, when an attack can be made through an ECU, an attacking ECU 15 may intrude into an in-vehicle network by broadcasting an attack packet. Further, when an intrusive attack made by the attacking ECU 15 is detected, the intrusion response apparatus 200 for the vehicle network may generate a response instruction message for instructing a target ECU to modify the RTR bit of a CAN packet which is being broadcasted, and may send the response instruction message to the target ECU. The modified CAN packet may be continuously broadcasted. That is, the RTR bit of a CAN packet being broadcasted may be modified by the target ECU. The CAN packet which is a target of the modification may have the CAN ID of the attack packet.

As illustrated in FIG. 9, a CAN ID value is stored in a message identifier field 910 of a CAN packet 900, and a value of 0 or 1 is stored in an RTR bit 920, which is a field for distinguishing a remote frame from a data frame. Here, the case where the RTR bit 920 is 0 may mean that the CAN packet 900 is a data frame, and the case where the RTR bit 920 is 1 may mean that the corresponding CAN packet 900 is a remote frame.

When the CAN packet 900 in which the RTR bit 920 is set to 0 is broadcasted, an ECU 10, having received the corresponding CAN packet 900, checks the CAN ID and then determines whether to process the CAN packet 900. At this time, when it is determined that the CAN packet 900 is a frame of interest as a result of checking of the CAN ID, the ECU 10 processes the corresponding CAN packet.

By utilizing this point, the attacking ECU 15 may use the CAN packet 900 for an attack such as a DoS attack, and may designate the CAN packet 900 to include an unapproved packet or unauthorized control command.

As illustrated in FIG. 8, when an attack made by the attacking ECU 15 to broadcast an attack packet is detected, the intrusion response apparatus 200 for the vehicle network sends a response instruction message for incapacitating the attack packet to the target ECU. Here, the intrusion response apparatus 200 for the vehicle network may incapacitate the attack packet by changing the RTR bit 920 of a packet corresponding to the attack packet to ‘1’.

Here, the response instruction message refers to a message for instructing the target ECU to change the RTR bit 920 of the packet including the CAN ID of the attack packet, among packets broadcasted over the CAN bus, to ‘1’. Here, the target ECU, having received the response instruction message, may change the RTR bit 920 to ‘1’ through voltage adjustment.

For example, as illustrated in FIG. 8, when the CAN ID of the attack packet broadcasted by the attacking ECU 15 is 0×01, the intrusion response apparatus 200 for the vehicle network may send a response instruction message for instructing the target ECU to change the RTR bit 920 of a packet, the message identifier (ID) 910 of which is 0×01, among the packets on the CAN bus, to ‘1’, to the target ECU. Therefore, the RTR bit 920 of the packet is changed from ‘0’ to ‘1’ by the target ECU.

The ECUs, having received the packet in which the RTR bit 920 has changed to ‘1’, drop the received packet. That is, in the case of the frame in which the RTR bit 920 is set to ‘1’, only an ECU having the CAN ID of the corresponding packet receives the packet and returns the status thereof, whereas ECUs not having the CAN ID of the corresponding packet may discard the packet without listening to the packet, and may be prevented from being damaged by the attack packet.

When the packet in which RTR bit 920 has changed to ‘1’ is broadcasted, only the attacking ECU 15 receives the corresponding attack packet, and the remaining ECUs 10 may drop and discard the attack packet. Thus, the intrusion response apparatus 200 for the vehicle network may protect the ECUs 10 in the vehicle from the attack packet, and may take measures, in real time, for responding to the attack packet and mitigating the damage caused by the attack packet so as to minimize the damage.

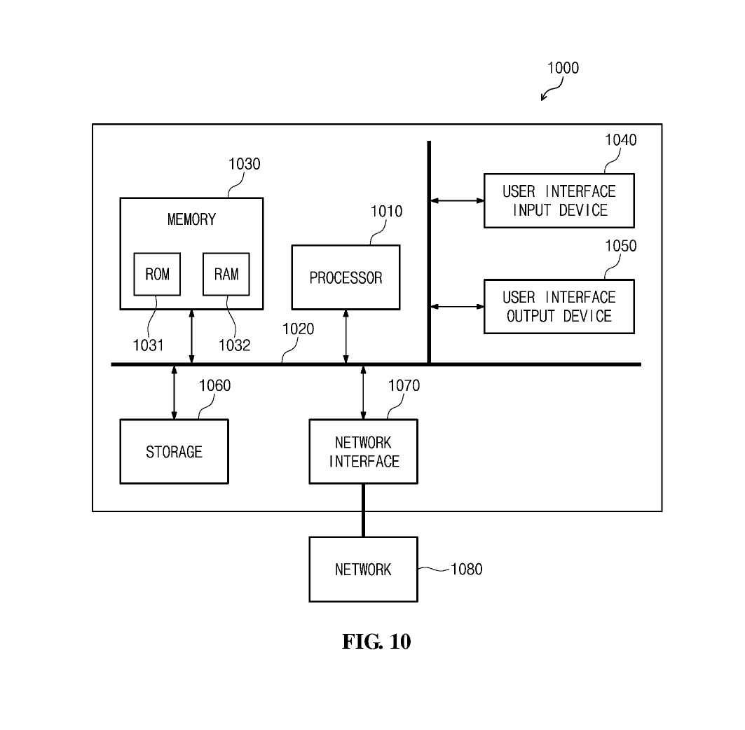

FIG. 10 is a block diagram illustrating a computer system according to an embodiment of the present invention.

Referring to FIG. 10, the embodiment of the present invention may be implemented in a computer system 1000 such as a computer-readable storage medium. As illustrated in FIG. 10, the computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing processing instructions stored in the memory 1030 or the storage 1060. Each of the memory 1030 and the storage 1060 may be any of various types of volatile or nonvolatile storage media. For example, the memory 1030 may include Read-Only Memory (ROM) 1031 or Random Access Memory (RAM) 1032.

Therefore, the embodiment of the present invention may be implemented as a non-transitory computer-readable medium in which a computer-implemented method is recorded or in which computer-executable instructions are recorded. When the computer-executable instructions are executed by the processor, the instructions may perform the method according to at least one aspect of the present invention.

In accordance with the present invention, when an intrusion into an in-vehicle network is detected, measures for responding to and mitigating, in real time, the intrusion may be taken to minimize the damage caused by the intrusion.

In accordance with the present invention, when an intrusion into the in-vehicle network is detected, vehicle availability may be secured, and response to an invasive attack on the in-vehicle network may be performed.

As described above, in the intrusion response apparatus and method for a vehicle network according to the present invention, the configurations and schemes in the above-described embodiments are not limitedly applied, and some or all of the above embodiments can be selectively combined and configured such that various modifications are possible.

What is claimed is:

1. An intrusion response method for a vehicle network, performed by an intrusion response apparatus for the vehicle network, the intrusion response method comprising:
receiving attack detection information about an intrusive attack on the vehicle network from an intrusion detection system;
selecting at least one target electronic control unit that is to be instructed to respond to the intrusive attack from among multiple electronic control units; and
sending a response instruction message to the at least one target electronic control unit so that the target electronic control unit responds to the intrusive attack.

2. The intrusion response method of claim 1, wherein receiving the attack detection information is configured to receive the attack detection information including at least one of a Controller Area Network (CAN) identifier (ID) of an attack packet detected by the intrusion detection system, a presumably damaged electronic control unit expected to be damaged by the intrusive attack, and a type of the intrusive attack.

3. The intrusion response method of claim 2, wherein selecting the target electronic control unit is configured to select, as the target electronic control unit, at least one of the presumably damaged electronic control unit expected to be damaged by the intrusive attack on the vehicle network and an electronic control unit selected based on a priority.

4. The intrusion response method of claim 3, wherein sending the response instruction message to the target electronic control unit is configured to send a response instruction message for instructing the target electronic control unit to perform at least one of a reboot operation, an operation of switching to a safe mode, and an operation of changing configuration information thereof.

5. The intrusion response method of claim 2, wherein sending the response instruction message to the target electronic control unit is configured to send a response instruction message including the CAN ID to the target electronic control unit, thus allowing the target electronic control unit to discard a packet corresponding to the CAN ID.

6. The intrusion response method of claim 2, wherein selecting the target electronic control unit is configured to, when the detected intrusive attack is an attack made through an infotainment system, select an electronic control unit included in an infotainment domain as the target electronic control unit.

7. The intrusion response method of claim 6, wherein sending the response instruction message to the target electronic control unit is configured to send a response instruction message for instructing the target electronic control unit to change configuration information of the infotainment system.

8. The intrusion response method of claim 2, wherein selecting the target electronic control unit is configured to, when the vehicle network comprises a domain gateway, select the domain gateway as a target that is to be instructed to respond to the intrusive attack.

9. The intrusion response method of claim 8, wherein sending the response instruction message to the target electronic control unit is configured to send a response instruction message for instructing the domain gateway, selected as the target, to perform at least one of an operation of changing domain configuration information, an operation of switching the domain to a security mode, and an operation of discarding a packet corresponding to the CAN ID.

10. The intrusion response method of claim 2, wherein sending the response instruction message to the target electronic control unit is configured to send a response instruction message for instructing the target electronic control unit to modify a Remote Transmission Request (RTR) bit of a broadcasted packet having the CAN ID of the attack packet.

11. The intrusion response method of claim 10, wherein an electronic control unit, having received the broadcasted packet, is configured to, when the electronic control unit is not an electronic control unit corresponding to the CAN ID of the attack packet, discard the packet.

12. An intrusion response apparatus for a vehicle network, comprising:
an attack detection information reception unit for receiving attack detection information about an intrusive attack on a vehicle network from an intrusion detection system;
an instruction target selection unit for selecting at least one target electronic control unit that is to be instructed to respond to the intrusive attack, from among multiple electronic control units; and
a response instruction message sending unit for sending a response instruction message to the at least one target electronic control unit so that the target electronic control unit responds to the intrusive attack.

13. The intrusion response apparatus of claim 12, wherein the attack detection information reception unit is configured to receive the attack detection information including at least one of a Controller Area Network (CAN) identifier (ID) of an attack packet detected by the intrusion detection system, a presumably damaged electronic control unit expected to be damaged by the intrusive attack, and a type of the intrusive attack.

14. The intrusion response apparatus of claim 13, wherein the instruction target selection unit is configured to select, as the target electronic control unit, at least one of the presumably damaged electronic control unit expected to be damaged by the intrusive attack on the vehicle network and an electronic control unit selected based on a priority.

15. The intrusion response apparatus of claim 14, wherein the response instruction message sending unit is configured to send a response instruction message for instructing the target electronic control unit to perform at least one of a reboot operation, an operation of switching to a safe mode, and an operation of changing configuration information thereof.

16. The intrusion response apparatus of claim 13, wherein the response instruction message sending unit is configured to send a response instruction message including the CAN ID to the target electronic control unit, thus allowing the target electronic control unit to discard a packet corresponding to the CAN ID.

17. The intrusion response apparatus of claim 13, wherein the instruction target selection unit is configured to, when the detected intrusive attack is an attack made through an infotainment system, select an electronic control unit included in an infotainment domain as the target electronic control unit.

18. The intrusion response apparatus of claim 17, wherein the response instruction message sending unit is configured to send a response instruction message for instructing the target electronic control unit to change configuration information of the infotainment system.

19. The intrusion response apparatus of claim 13, wherein the response instruction message sending unit is configured to send a response instruction message for instructing a domain gateway, selected as a target that is to be instructed to respond to the intrusive attack, from among domain gateways included in the vehicle network, to perform at least one of an operation of changing domain configuration information, an operation of switching the domain to a security mode, and an operation of discarding a packet corresponding to the CAN ID.

20. The intrusion response apparatus of claim 13, wherein the response instruction message sending unit is configured to send a response instruction message for instructing the target electronic control unit to modify a Remote Transmission Request (RTR) bit of a broadcasted packet having the CAN ID of the attack packet.
